(19) United States
(12) Patent Application Publication
(10) Pub. No.: US 2024/0063596 A1
(43) Pub. Date: Feb. 22, 2024

(54) ELECTRONIC DEVICE WITH DYNAMICALLY CONFIGURABLE CONNECTOR INTERFACE FOR MULTIPLE EXTERNAL DEVICE TYPES

(71) Applicant: Samsara Inc., San Francisco, CA (US)

(72) Inventors: Somasundara PANDIAN, San Francisco, CA (US); David GAL, Oakland, CA (US)

(73) Assignee: Samsara Inc., San Francisco, CA (US)

(21) Appl. No.: 18/052,396

(22) Filed: Nov. 3, 2022

Related U.S. Application Data
(60) Provisional application No. 63/371,944, filed on Aug. 19, 2022.

(51) Int. Cl. H01R 31/06; H01R 33/94; H01R 13/639; G06F 9/4401

(52) U.S. Cl. CPC H01R 31/065; H01R 33/94; H01R 13/639; G06F 9/4411

(57) ABSTRACT

An electronic device is described that includes an enclosure defining an internal volume and external surfaces, a connector interface comprising a plurality of conductors exposed at an external surface, and a memory and computer processor(s) disposed in the internal volume. The electronic device supports the connection of any one of a plurality of different types of external devices to the connector interface. The computer processor(s) receive, at a first conductor, a signal that distinguishes which one of the plurality of different types of external devices is currently connected to the connector interface. The computer processor(s) access, based on the received signal, a data structure in a storage of the memory that identifies at least one of a plurality of different communication protocols to use. The computer processor(s) assign one or more second conductors to communicate according to the at least one identified communication protocol.

### CROSS-REFERENCE TO RELATED APPLICATIONS

This application claims the benefit of U.S. Provisional Application No. 63/371,944, filed Aug. 19, 2022, which is hereby incorporated by reference.

### TECHNICAL FIELD

Embodiments described herein are directed to an electronic device with a dynamically configurable connector interface, and more specifically, to implementations having a connector interface that is particularly suitable for connection with multiple types of external devices, which may use different communication protocols.

### BACKGROUND ART

Vehicles are used for transportation of passengers and/or cargo, which in some cases may cover significant distances (e.g., hundreds or thousands of miles). The environmental parameters of one or more compartments of the vehicle may be monitored (sometimes in real-time) during a duration of the transport to ensure a suitable environment for the passengers and/or cargo being transported by the vehicle. Some monitored compartments may be required to support relatively harsh environments, such as high humidity and/or high temperature, low temperature, and so forth.

External sensors (such as temperature probes) may be used to remotely acquire measurements and may be connected to an electronic device using a connector interface. The physical connection of the external sensors with the connector interface may be degraded by various factors during the transportation process, such as an improper installation, vibrations during vehicle movement, and persons or items bumping or jostling the connection during loading and unloading operations. Further, the labor and parts needed to perform the repair or replacement of such degraded monitoring equipment may be expensive.

### BRIEF DESCRIPTION OF THE DRAWINGS

The following figures use like reference numbers to refer to like elements. Although the following figures depict various exemplary embodiments, alternative embodiments are within the spirit and scope of the appended claims. In the drawings:

FIG. 1 provides a block diagram of an exemplary electronic device, according to one or more embodiments.

FIG. 2A provides a perspective view of an electronic device having an exemplary connector interface at a bottom surface of an enclosure, according to one or more embodiments.

FIG. 2B provides a bottom view of the exemplary connector interface, according to one or more embodiments.

FIG. 2C provides a perspective view of an exemplary external connector, according to one or more embodiments.

FIG. 3 provides an exemplary method of dynamic configuration of a connector interface, according to one or more embodiments.

FIG. 4 illustrates an exemplary data structure that identifies at least one communication protocol used by an external device, according to one or more embodiments.

FIGS. 5A and 5B illustrate exemplary implementations of identification hardware of an external device, according to one or more embodiments.

### DETAILED DESCRIPTION

Embodiments described herein are directed to implementations of an electronic device comprising an enclosure that defines an internal volume and a plurality of external surfaces, and a connector interface comprising a plurality of conductors that are exposed at an external surface of the plurality of external surfaces, or through an opening formed in the external surface. The electronic device supports the connection of any one of a plurality of different types of external devices to the connector interface. The electronic device further comprises a memory disposed in the internal volume, and one or more computer processors disposed in the internal volume and configured to receive a signal, when one of the plurality of different types of external devices is currently connected to the connector interface, at a first conductor of the plurality of conductors. The signal distinguishes which one of the plurality of different types of external devices is currently connected to the connector interface. The one or more computer processors are further configured to access, based on the received signal, a data structure in a storage of the memory that identifies at least one of a plurality of different communication protocols to use based on which one of the plurality of different types of external devices is currently connected to the connector interface according to the received signal. The one or more computer processors are further configured to assign one or more second conductors of the plurality of conductors to communicate according to the at least one identified communication protocol. The one or more second conductors are operated differently when different ones of the plurality of communication protocols are used.

In some embodiments, the one or more computer processors are further configured to perform processing of the received signal, such as measuring a voltage of the received signal. Accessing the data structure comprises performing a lookup in the data structure using a result of the processing (e.g., the measured voltage value). The data structure comprises a plurality of records. In some embodiments, the plurality of records comprise at least a first record that identifies a single protocol to use based on a value of a signal characteristic field for the received signal, and at least a second record that identifies multiple protocols to use based on the value of the signal characteristic field. In some embodiments, the data structure further comprises, within one or both of the first record and the second record, one or more application fields that identify an operational type of the external device.

The ability to configure the connector by assigning some of its conductors based on the type of external device connected thereto provides many advantages. For instance, manufacturing costs are typically lower for an electronic device with less connectors (e.g., just one) relative to an electronic device with more connectors. Additionally, a single type of electronic device being capable of use with different external devices allows for saving from volume production of the electronic device. Also, there may be cost savings from selling/supporting/training a single electronic device type (or at least fewer types) as compared to more electronic device types for different purposes, that support different protocols, and/or that support the connection of different external device types. Further, beneficially, the embodiments described herein provide a highly cost-effective approach to the replacement of external devices (such as sensor probes) without requiring reconfiguration or other substantial intervention by human users. These techniques may be beneficial from a maintenance perspective, both for replacing degraded external devices and for extending the lifetime of the electronic device, which may easily be redeployed to support different sensor configurations. As the electronic device supports communicating with external devices using any of a number of different communication protocols, the number and/or types of external devices suitable for use in the monitoring equipment is greatly increased, which tends to lower costs. Further, supporting communicating with the external devices using the different communication protocols contemplates an expanded functionality of the monitoring equipment, which may be beneficial for occasional upgrades of the monitoring equipment to support new sensor capabilities.

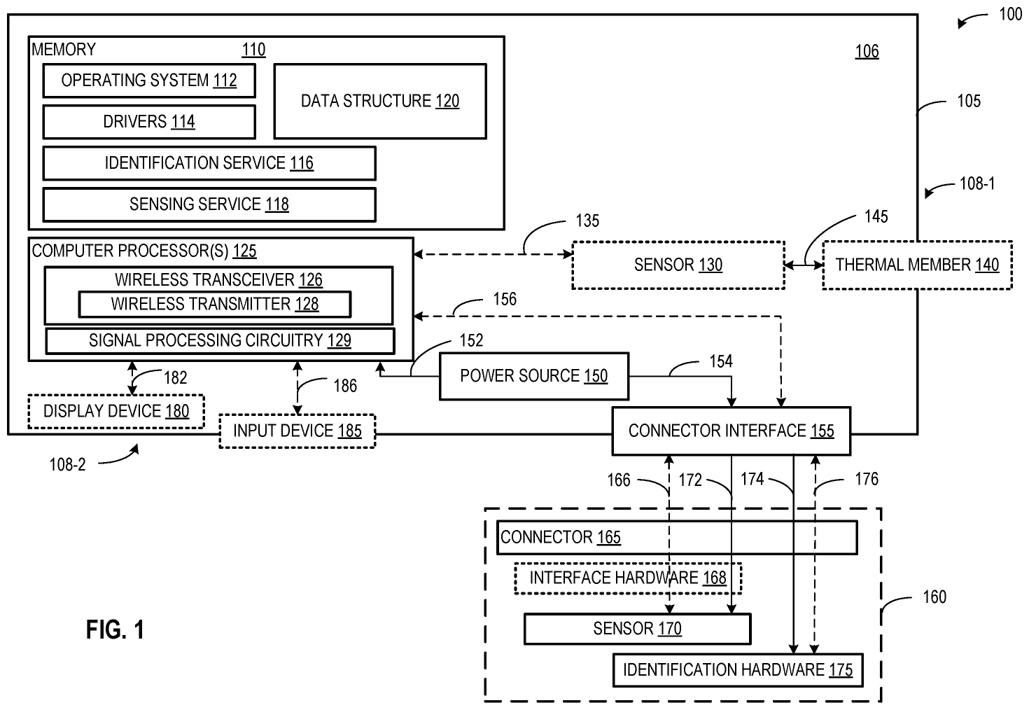

FIG. 1 provides a block diagram of an exemplary electronic device 100, according to one or more embodiments. The electronic device 100 comprises an enclosure 105 that defines an internal volume 106 and a plurality of external surfaces 108-1, 108-2. Although two (2) external surfaces 108-1, 108-2 are illustrated for simplicity of description, any other number of external surfaces are also contemplated. In some embodiments, the dimensioning of the plurality of external surfaces 108-1, 108-2 and their relative disposition are selected to prevent ingress of liquids into the internal volume 106.

A plurality of electronic components are disposed within the internal volume 106, which generally includes computing hardware such as a memory 110, one or more computer processors 125, a display device 180, and an input device 185.

The memory 110 may include a variety of computer-readable media selected for relative performance or other capabilities: volatile and/or non-volatile media, removable and/or non-removable media, etc. The memory 110 may include cache, random access memory (RAM), storage, etc. Storage included in the memory 110 typically provides a non-volatile memory for the electronic device 100, and may include one or more different storage elements such as Flash memory, a hard disk drive, a solid state drive, an optical storage device, and/or a magnetic storage device.

The one or more computer processors 125 generally include any processing element(s) capable of performing various functions described herein. Some non-limiting examples of the one or more computer processors 125 include a microprocessor, a digital signal processor (DSP), an application-specific integrated chip (ASIC), and a field programmable gate array (FPGA). While depicted as a single element within the electronic device 100, the one or more computer processors 125 contemplates a single processor, multiple processors, a processor or processors having multiple cores, as well as combinations thereof. In one embodiment, the one or more computer processors 125 represents a central processing unit (CPU) of the electronic device 100.

The one or more computer processors 125 comprise wireless transceiver circuitry 126, which comprises wireless transmitter circuitry 128 and wireless receiver circuitry (not shown). In some alternate implementations, the wireless transceiver circuitry 126 and/or the wireless transmitter circuitry 128 may be implemented separately from the one or more computer processors 125.

In some embodiments, the one or more computer processors 125 further comprise signal processing circuitry 129 for processing signals received from an external device 160 (e.g., an external sensor) and/or from sensor(s) disposed in the internal volume 106. The signal processing circuitry 129 may include any suitable functionality, such as measurement and conditioning of the received signals, which may be performed in the analog and/or digital domains.

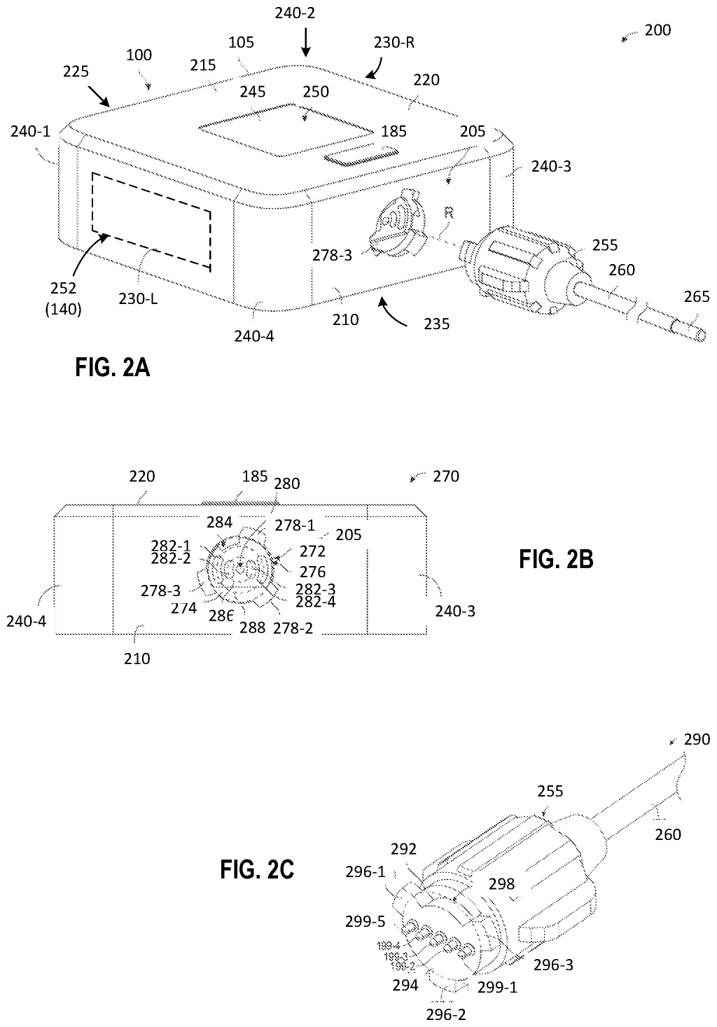

A connector interface 155 comprises a plurality of conductors that are exposed at the external surface 108-2, or through an opening formed in the external surface 108-2. The connector interface 155 is connected to the one or more computer processors 125 and to a power source 150 disposed within the internal volume 106, and provides external power and/or signal connectivity from the electronic device 100 to the external device 160. As shown, a power link 154 comprising one or more conductors extends between the power source 150 and one or more of the plurality of conductors of the connector interface 155, and a communicative link 156 comprising one or more conductors extends between the one or more computer processors 125 and one or more of the plurality of conductors of the connector interface 155. The electronic device 100 supports the connection of one of any one of a plurality of different types of external devices 160 to the connector interface 155, as well as supports disconnection of a currently connected external device 160 and connection of a different external device 160 (whether of the same type or of a different one of the plurality of different types). Further implementation details of an exemplary implementation of the connector interface 155 are described below with respect to FIGS. 2A-2C.

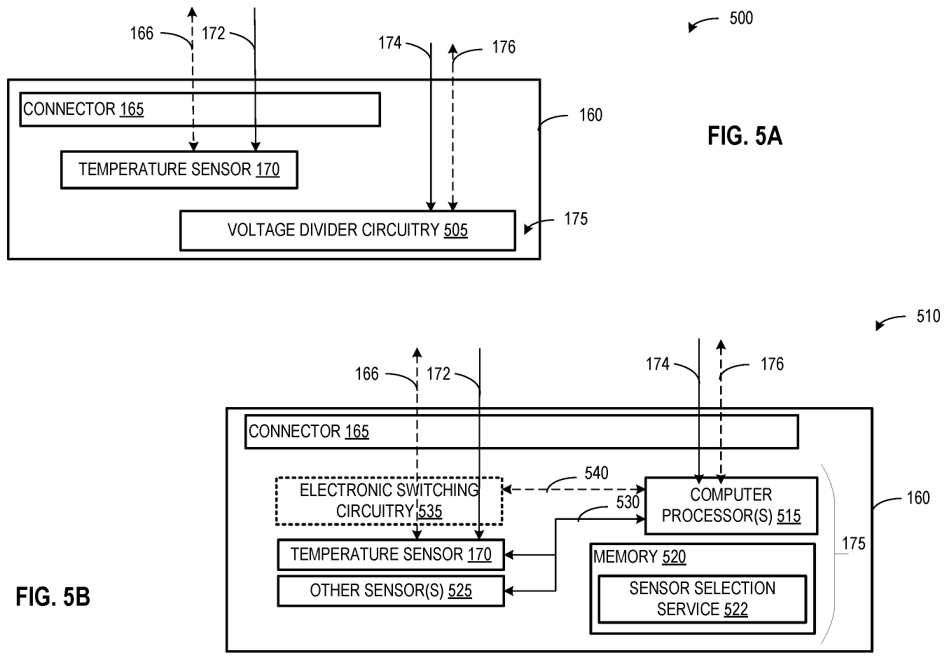

The external device 160 includes one or more active components (e.g., electronic components) and/or one or more passive components, and may be implemented in any suitable form. Some non-limiting examples of the external device 160 include a sensor probe, another electronic device, and so forth. As shown, the external device 160 comprises a sensor 170 (e.g., a temperature sensor) that acquires measurements of one or more parameters (e.g., temperature measurements) at a location external to, and which may be remote from, the electronic device 100. The sensor 170 may have any suitable implementation. Using the example of a temperature sensor, the temperature sensor may be implemented as a thermocouple, a resistance temperature detector (RTD), a thermistor, and so forth. The external device 160 further comprises identification hardware 175 that transmits a signal to the electronic device 100 that distinguishes a type of the external device 160 that is currently connected to the connector interface 155. The identification hardware 175 comprises one or more active components and/or one or more passive components, which are described in greater detail below with respect to FIGS. 5A and 5B.

A connector 165 comprises a plurality of conductors that connect to respective ones of the plurality of conductors of the connector interface 155 when the connector 165 mates with the connector interface 155. In some embodiments, the connector 165 is integrated into the external device 160 (e.g., where the external device 160 is implemented as a sensor probe). In other embodiments, the connector 165 is separate from the external device 160 (e.g., included in a removable cable that connects between the connector interface 155 and the external device 160). As shown, the connector interface 155 provides a communicative link 166 and a power link 172 through the connector 165 to the sensor 170, and further provides a communicative link 176 and a power link 174 through the connector 165 to the identification hardware 175. Each of the communicative links 166, 176 and the power links 172, 174 comprises a respective one or more conductive paths established between one or more conductors of the connector interface 155 and one or more conductors of the connector 165, which may include one or more conductors interposed therebetween (e.g., a wire of a removable cable). Although two power links 172, 174 are shown in FIG. 1, alternate implementations may include different numbers of power links. For example, electrical power may be received by the external device 160 using a single power link, and the external device 160 may further include power distribution circuitry that distributes processed or conditioned electrical power to the various components of the external device 160.

The protocol(s) used by the external device 160 may require particular interface hardware 168 (e.g., at the physical layer). For example, the FC protocol requires a pull-up resistor on each of the serial data (SDA) and the serial clock (SCL) conductors (wires). In various embodiments described herein, the interface hardware 168 is implemented external to the electronic device 100, such that the electronic device 100 may support connection with external devices 160 using different protocols without requiring the electronic device 100 to include all of the various configurations of the interface hardware 168.

Thus, in some implementations, the external device 160 comprises the interface hardware 168. In other implementations, the connector 165 and the interface hardware 168 are included in the removable cable that connects between the connector interface 155 and the external device 160. The interface hardware 168 comprising active component(s) and/or passive component(s) required by the protocol(s) used by the external device 160, which may not be required for other ones of the protocols supported by the electronic device 100. As shown, the interface hardware 168 is disposed between the sensor 170 and the connector 165 (e.g., along the conductive paths established with one or more of the conductors of the connector 165). Using the example of the FC protocol, the interface hardware 168 may include pull-up resistors disposed along the conductive paths with respective conductors of the connector 165. Other examples of the interface hardware 168 include capacitors, current sources, and so forth. In some embodiments, the interface hardware 168 comprises component(s) that support application of one or more protocols from a plurality of supported protocols, and electronic switching circuitry that connects the particular component(s) for the selected one or more protocols, sets the values of the particular component(s), and so forth. In one non-limiting example, the electronic switching circuitry connects a pull-up resistor to a conductor of the connector interface 155 when applying a first protocol, connects a current source to the conductor when applying a second protocol, and does not connect any components when applying a third protocol. In another non-limiting example, the electronic switching circuitry sets a first value of a pull-up resistor when applying a first protocol, and sets a second value of the pull-up resistor when applying a second protocol.

In some embodiments, the signal provided by the identification hardware 175 using the communicative link 176 is based on electrical power provided using the power link 174 and/or based on a signal provided to the identification hardware 175 using the communicative link 176. In one non-limiting example, the identification hardware 175 comprises voltage divider circuitry that outputs a voltage that is based on the voltage of the electrical power (or of the signal) received from the electronic device 100. For example, the identification hardware 175 may receive a supply voltage (VDD) of 3 volts direct current (V DC), and may output a signal of 1.2 V DC that distinguishes the type of the external device 160 from other types of external devices 160. Alternate implementations of the identification hardware 175 may modulate any other parameter(s) of the electrical power or of the signal, whether in the analog domain or in the digital domain.

In another non-limiting example, the external device 160 may include a plurality of different sensor types, and the identification hardware 175 may receive a configuration signal from the electronic device 100 that provides a requested sensor configuration. The configuration signal may be provided on a conductor of the power link 174 (e.g., a DC level that is controlled to indicate the requested sensor configuration, an added modulation component), or on a separate conductor of the connector interface 155 (e.g., on a conductor of the communicative link 176). In response, the external device 160 may configure the connectivity of the sensors to the connector 165 (e.g., operate electronic switching circuitry connected to the selected sensors).

The memory 110 stores (i.e., in a non-volatile portion of the memory 110) an operating system 112 and drivers 114. The operating system 112 represents computer-readable code that may have any suitable implementation for execution by the one or more computer processors 125. The drivers 114 represent computer-readable code that enables the operating system 112 to communicate with other hardware, such as the different types of external devices 160 that may be connected to the connector interface 155.

The memory 110 further stores an identification service 116 that operates based on the signal received from the external device 160 when one of the plurality of different types of external devices 160 is currently connected to the connector interface 155. The signal is received at a first conductor of the plurality of conductors of the connector interface 155. The signal distinguishes which one of the plurality of different types of external devices 160 is currently connected to the connector interface 155, where the different types may represent different protocols and/or different applications used by the external device 160.

In some embodiments, receiving the signal from the external device 160 is responsive to an external connector (e.g., the connector 165) of the external device 160 being connected to the connector interface 155. In some embodiments, the external device 160 does not include a power source, and receives electrical power supplied by the electronic device 100 through the connector interface 155 (e.g., the power links 172, 174) that powers up the various components of the external device 160. In other embodiments, the external device 160 includes a power source.

In some embodiments, the signal processing circuitry 129 performs processing of the received signal and the identification service 116 receives a result of the processing. The processing may include any suitable measurement(s) (e.g., determining one or more signal characteristics) and/or conditioning of the received signal from the external device 160, which may be performed in the analog and/or digital domains. In one non-limiting example, the processing comprises measuring a voltage of the received signal. In another non-limiting example, the processing comprises a representation of the signal.

The identification service 116 accesses, based on the received signal from the external device 160, a data structure 120 of the memory 110 that identifies at least one of a plurality of different communication protocols to use based on which one of the plurality of different types of external devices 160 is currently connected to the connector interface 155 according to the received signal. The data structure 120 generally comprises a plurality of records, each of which includes a plurality of fields. Alternate formats of the data structure 120 are also contemplated. In some embodiments, accessing the data structure 120 comprises performing a lookup in the data structure 120 using a result of the processing of the received signal, e.g., using the measured voltage of the received signal to identify a record within the data structure 120.

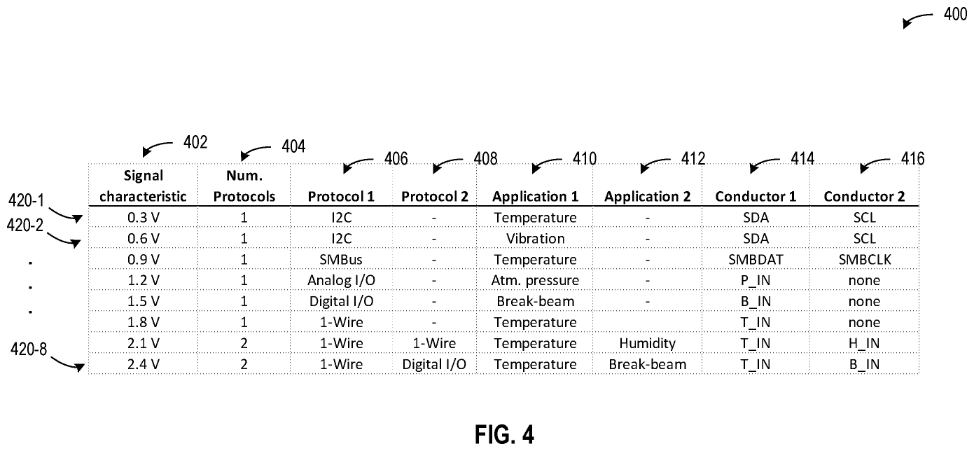

In some embodiments, the data structure 120 comprises one or more records that identify a single protocol to use based on a value of a signal characteristic field for the received signal, one or more records that identify multiple protocols to use based on the value of the signal characteristic field, or combinations thereof. Further details of the data structure 120 are discussed below with respect to FIG. 4.

In some embodiments, the identification service 116 retrieves one or more of the drivers 114 from the memory 110 for the at least one identified communication protocol. The identification service 116 enables the one or more of the drivers 114 (e.g., within the operating system 112) to enable the electronic device 100 to communicate with the external device 160 according to the at least one identified communication protocol.

The identification service 116 assigns one or more second conductors of the plurality of conductors of the connector interface 155 to communicate according to the at least one identified communication protocol. In this way, the one or more second conductors of the connector interface 155 are operated differently by the electronic device 100 when different ones of the plurality of communication protocols are used (e.g., for different types of external devices 160 when connected to the connector interface 155). Although two (2) second conductors are provided as an example throughout the description for simplicity, any alternate number of second conductors are also contemplated (e.g., one (1), three (3), four (4) or more), which may support communicating according to any suitable number of communication protocols (e.g., one (1), two (2), three (3) or more).

The memory 110 further comprises a sensing service 118 that processes sensor data received from the sensor 130 and/or the sensor 170. In some embodiments, the sensing service 118 acquires sensor measurements from the sensor 130 and/or the temperature sensor 170, and performs one or more other operations using some or all of the sensor measurements. For example, the sensing service 118 may determine a parameter based on some or all of the sensor measurements, may store some or all of the sensor measurements (or the parameter) in a non-volatile memory, may wirelessly transmit signals representative of the sensor measurements (or the parameter) to one or more external electronic devices using the wireless transmitter 128, may transmit signals representative of the sensor measurements (or the parameter) to the display driver circuitry of the one or more computer processors 125, and so forth.

Although the discussion is primarily directed to implementations of the electronic device 100 with an enclosure 105 having dimensions typically on the order of centimeters or tens of centimeters, other embodiments may implement various aspects of the electronic device 100 within an integrated circuit (such as a system-on-a-chip (SoC)). In such cases, the one or more computer processor(s) 125 may be one or more processor cores of the integrated circuit, such as an application core and a network cord. The plurality of conductors of the (external) connector interface 155 may be a plurality of general-purpose input/output (GPIO) pins of the integrated circuit, which in some cases are individually assignable to any one of a plurality of functions supported by the one or more processor cores.

In some embodiments, the power source 150 is used to provide electrical power to one or more electronic components within the internal volume 106 and/or of the external device 160. The power source 150 supplies electrical power to various electronic components of the electronic device 100, which may include components within the internal volume 106 as well as external components electrically connected through the connector interface 155. As shown, a power link 152 comprising one or more conductors extends between the power source 150 and the one or more computer processors 125. Although not shown, the power source 150 may further be connected to the display device 180, the input device 185, and/or the sensor 130 to provide each with electrical power.

In some embodiments, the power source 150 comprises a removable battery (whether one-time use or rechargeable) using any suitable energy storage technology, such as alkaline, lithium, lithium-ion, nickel metal hydride, and so forth. The dimensions of the battery may be standardized (e.g., a “AA” battery) or may have a proprietary form factor. In alternate implementations, the battery may be non-removable and rechargeable. For example, the battery may be recharged through the enclosure 105, e.g., using an inductive charging coil disposed in the internal volume 106.

The display device 180 is disposed in the internal volume 106 and may be viewable at an external surface of the enclosure 105 (e.g., the external surface 108-2) while maintaining the ingress protection of the enclosure 105. The display device 180 may use any suitable display technology, such as liquid-crystal display (LCD), light-emitting diode (LED), organic LED (OLED), and so forth. The display device 180 receives electric power from the power source 150, either directly or via the one or more computer processors 125. In some embodiments, the one or more computer processors 125 may further include display driver circuitry (not shown) to drive display signals to the display device 180 using a communicative link 182, which generally comprises one or more conductors and may support bidirectional communication.

The input device 185 may be disposed at an external surface of the enclosure 105 (e.g., the external surface 108-2) while maintaining the ingress protection of the enclosure 105. The input device 185 may have any suitable form, such as a physical button extending from the external surface. The input device 185 communicates input signals with the one or more computer processors 125 using a communicative link 186, which generally comprises one or more conductors and may support bidirectional communication. Alternate implementations of the input device 185 may use any suitable input sensing technology (e.g., resistive, capacitive, inductive, optical). For example, the input device 185 may be a capacitive sensing device that overlaps with the display device 180 and/or may include shared circuitry (e.g., substantially transparent electrodes).

The input device 185 and the display device 180 are connected with each other through the one or more computer processors 125 of the electronic device 100. In some embodiments, the displayed content (e.g., information) on the display device 180 is responsive to inputs received at the input device 185. For example, receiving a first press at the input device 185 may activate the display device 180 and may cause a first set of content to be displayed (e.g., a measurement taken by an external device connected to the connector interface 155), receiving a second press at the input device 185 may display a second set of content (status of wireless connectivity strength, battery status, etc.) to be displayed, and so forth. In some embodiments, inputs received at the input device 185 may provide user configuration information for the electronic device 100.

In some embodiments, the electronic device 100 is configured to operate as a sensor device, and sensor hardware such as a sensor 130 is disposed within the internal volume 106. Other types of sensors are also contemplated. The sensor 130 may have any suitable implementation, such as a thermocouple, a resistance temperature detector (RTD), a thermistor, and so forth.

In some embodiments, the external surface 108-1 defines an opening extending fully or partially through the structure of the enclosure 105. In some embodiments, a thermal member 140 is disposed in the opening and exposed to both the internal volume 106 and the ambient environment of the electronic device 100. The thermal member 140 provides improved thermal conductivity, when compared with other portions of the enclosure 105, while maintaining the ingress protection of the enclosure 105. The thermal member 140 is thermally contacted to the sensor 130. The thermal member 140 improves the thermal responsivity of the electronic device 100 and supports greater sampling rates of the temperature of the ambient environment while maintaining the ingress protection of the enclosure 105. The thermal member 140 may be formed of any suitable material(s) and may have any dimensioning that provides a suitable thermal conductivity for the sensor 130, and that provides suitable strength to maintain the ingress protection of the enclosure 105. In some embodiments, the thermal member 140 comprises a metal, such as aluminum or stainless steel.

In some embodiments, some or all of the functionality of the electronic device 100 (including any of the signal processing, display driver, and/or input sensing that are discussed above) may optionally be implemented in computer-readable code that is stored in the memory 110 and executed by the one or more computer processors 125. In this way, various aspects of the present disclosure may take the form of entirely hardware embodiments, entirely software embodiments (which includes firmware, resident software, microcode, etc.) or embodiments combining software and hardware aspects that may all generally be referred to herein as a “circuit,” “module,” or “system.”

FIG. 2A provides a perspective view 200 of the electronic device 100 having an exemplary connector interface 155 at a bottom surface 210 of the enclosure 105, according to one or more embodiments.

The electronic device 100 comprises the enclosure 105 that defines the internal volume 106 and a plurality of external surfaces (e.g., examples of the external surfaces 108-1, 108-2 of FIG. 1). The enclosure 105 houses one or more components that provide various functionality of the electronic device 100. As shown, the enclosure 105 comprises a first cover member 215 (e.g., a cap) and a second cover member (not shown; e.g., a base plate) that are removably attachable with each other, e.g., using threaded fasteners distributed around a perimeter of the enclosure 105. In other implementations, the enclosure 105 may include different numbers of cover members, e.g., being formed of a single cover member that defines the internal volume 106 and the plurality of external surfaces.

In some embodiments, the enclosure 105 prevents the ingress of liquids (e.g., water) and/or particulates (e.g., dust) into the internal volume 106 of the enclosure 105. In some embodiments, the second cover member removably attaches to the first cover member 215 to form a sealed interface that seals the internal volume 106 from the ambient environment. For example, one of the first cover member 215 and the second cover member may include a gasket or other compliant material that contacts the other of the first cover member 215 and the second cover member to form the sealed interface. In some embodiments, the enclosure 105 may have an Ingress Protection (IP) Code rating, such as IP66, IP66K, IP67, IP68, IP69K, and so forth. By limiting or preventing ingress of liquids and/or particulates into the internal volume, the electronic device 100 may provide increased longevity and increased reliability of the components in the internal volume 106. Further, in some cases the electronic device 100 having ingress protection may be deployed and reliably operate in harsher environments. In one example, the electronic device 100 may be deployed in a cargo compartment of a truck or trailer (e.g., attached to a wall of the cargo compartment), and the electronic device 100 may remain deployed during washing (e.g., power washing) or other cleaning of the cargo compartment.

The first cover member 215 defines a front surface 220, a top surface 225, side surfaces 230-L, 230-R, and the bottom surface 210 of the enclosure 105, and the second cover member defines a rear surface 235 of the enclosure 105. The front surface 220, the top surface 225, the side surfaces 230-L, 230-R, the bottom surface 210, and the rear surface 235 may be referred to generically or collectively as external surface(s) of the enclosure 105.

As shown, the external surfaces of the enclosure 105 are planar, although other configurations are also contemplated. In some embodiments, the front surface 220 is in a first plane, and the top surface 225, the side surfaces 230-L, 230-R, and the bottom surface 210 are in respective second planes that are orthogonal to the first plane. In some embodiments, when the first cover member 215 and the second cover member are attached, the rear surface 235 is in a third plane that is parallel to the first plane and orthogonal to each of the second planes.

The enclosure 105 may have any suitable external profile. In some embodiments, the external surfaces of the enclosure 105 extend to each other (e.g., forming right angle interfaces with each other). In some embodiments, the enclosure 105 further includes transition sections between different ones of the front surface 220, the top surface 225, the side surfaces 230-L, 230-R, the bottom surface 210, and the rear surface 235, where the transition sections may also form external surfaces of the enclosure 105. In another example, the transition sections include curved corner sections 240-1, 240-2, 240-3, 240-4 that extend between various pairs of the top surface 225, the side surfaces 230-L, 230-R, and the bottom surface 210. In another example, and as shown in the view 200, the transition sections include beveled edges that extend between the front surface 220 and each of the top surface 225, the side surfaces 230-L, 230-R, the bottom surface 210, and the curved corner sections 240-1, 240-2, 240-3, 240-4. Beneficially, the transition sections of the enclosure 105 allow the electronic device 100 to have a reduced external profile, which reduces the likelihood of the electronic device 100 being intentionally or incidentally contacted (e.g., bumped or snagged) while deployed, and/or reduces the likelihood of such contact causing dislocation or damage to the electronic device 100.

The front surface 220 of the enclosure 105 defines an opening 245 extending through the first cover member 215. As shown, the opening 245 is disposed near a center of the front surface 220 and is square-shaped. A window 250 is disposed in the opening 245 that provides visible transmissivity into the internal volume 106 of the enclosure 105 through the first cover member 215 while maintaining the ingress protection of the enclosure 105. Any suitable arrangement and/or materials of the window 250 are contemplated. In one non-limiting example, the window 250 is formed of an acrylic, such as poly(methyl methacrylate) (PMMA). The window 250 may be adhered to the first cover member 215 using a suitable adhesive. The window 250 may be recessed slightly from the front surface 220, such as 0.05 millimeter (mm). In an alternate implementation, the front surface 220 comprises a sheet of material (e.g., acrylic) that is masked (e.g., silkscreen painted) to define the transparent window 250 and the non-transparent portions of the front surface 220.

In some embodiments, the display device 180 of the electronic device 100 is disposed beneath the window 250, such that the display device 180 is viewable at the front surface 220 through the window 250 (e.g., from outside the electronic device 100). In some embodiments, the electronic device 100 comprises the input device 185 disposed at the front surface 220 and that maintains the ingress protection of the enclosure 105. Although the input device 185 is depicted as a physical button extending outwardly from the front surface 220, alternate implementations of the input device 185 may have other forms and/or may be disposed at different external surface(s) of the enclosure 105. Further, alternate implementations may have multiple input devices 185 disposed at one or more of the external surfaces of the enclosure 105. Alternate implementations of the input device 185 may use any suitable input sensing technology (e.g., resistive, capacitive, inductive, optical). For example, the input device 185 may be a capacitive sensing device that is also disposed at the window 250. In some embodiments, the display device 180 and the input device 185 may overlap with each other and/or may include shared circuitry (e.g., substantially transparent electrodes).

The input device 185 and the display device 180 are connected with each other through the one or more computer processors 125 of the electronic device 100 that are disposed in the internal volume 106. In some embodiments, the displayed content (e.g., information) on the display device 180 is responsive to inputs received at the input device 185. For example, receiving a first press at the input device 185 may activate the display device 180 and may cause a current measurement to be displayed, receiving a second press at the input device 185 may display a measurement of a different parameter monitored by the electronic device 100, and so forth. In this way, receiving multiple inputs at the input device 185 may cause the display device 180 to cycle through a predefined sequence of presenting information to a user. In some embodiments, inputs received at the input device 185 may provide user configuration information for the electronic device 100.

In some embodiments, one or more of the external surfaces of the enclosure 105 (e.g., the side surface 230-L) defines an opening 252 that extends through the first cover member 215, and the thermal member 140 is disposed in the opening 252. The thermal member 140 improves the thermal responsivity of the electronic device 100 and supports greater sampling rates of the temperature of the ambient environment while maintaining the ingress protection of the enclosure 105. The thermal member 140 may be formed of any suitable material(s) and may have any dimensioning that provides a suitable thermal conductivity for the sensor 130, and that provides suitable strength to maintain the ingress protection of the enclosure 105, e.g., a metal such as aluminum or stainless steel. The thermal member 140 may be attached to, or integrally formed with, the enclosure 105 using any suitable techniques. The external surface of the thermal member 140 may be flush with the side surface 230-L or slightly recessed from the side-surface 230-L.

Referring also to FIGS. 2B and 2C, a connector interface 205 (one exemplary implementation of the connector interface 155) is disposed at the bottom surface 210 of the enclosure 105. An external connector 255 (one exemplary implementation of the connector 165) of a connectorized cable 260 removably attaches to the electronic device 100 at the connector interface 205, and a plurality of second conductors 299-1, 299-2, 299-3, 299-4, 299-5 of the external connector 255 connect through a plurality of first conductors 280, 282-1, 282-2, 282-3, 282-4 of the connector interface 205 to one or more electronic components disposed in the internal volume 106 of the electronic device 100. In one embodiment, an external sensor 265 (e.g., an external temperature sensor) is connected via the connectorized cable 260 to the external connector 255, and the measurements acquired by the external sensor 265 and/or other data may be transmitted through the connector interface 205 to the one or more computer processors 125 of the electronic device 100. In other embodiments, the connector interface 205 may be used to connect the electronic device 100 to other suitable types of sensors or to other electronic devices.

In the bottom view 270, a recess 272 extends into a structure of the enclosure 105 (e.g., partly through a wall of the enclosure 105). More specifically, the recess 272 extends from the bottom surface 210 to a recessed surface 274. The recess 272 defines a central recess 276 and a plurality of circumferential slots 278-1, 278-2, 278-3 that are spaced apart from each other along a circumference of the central recess 276. As shown, the plurality of circumferential slots 278-1, 278-2, 278-3 are evenly distributed along the circumference of the central recess 276 (i.e., three slots spaced apart by 120 degrees). Other numbers of the circumferential slots are also contemplated (e.g., one, two, four or more), as well as different spacing between the circumferential slots (which may include regular and irregular spacing).

In some embodiments, the central recess 276 has a substantially cylindrical shape, although the central recess 276 may be contoured differently in other implementations. As shown, the plurality of circumferential slots 278-1, 278-2, 278-3 are in fluid communication with the central recess 276, although alternate implementations may have some or all of the plurality of circumferential slots 278-1, 278-2, 278-3 spaced apart from the central recess 276.

A plurality of first conductors 280, 282-1, 282-2, 282-3, 282-4 are exposed to the recess 272 at the recessed surface 274, and exposed to the ambient environment of the electronic device 100 through the bottom surface 210. In some embodiments, the connector interface 205 includes a printed circuit board (PCB) that partly or fully defines the recessed surface 274, and the plurality of first conductors 280, 282-1, 282-2, 282-3, 282-4 are disposed on the PCB. In some embodiments, each of the plurality of first conductors 280, 282-1, 282-2, 282-3, 282-4 has a planar endface at the recessed surface 274. In one example, the endfaces of the plurality of first conductors 280, 282-1, 282-2, 282-3, 282-4 are coplanar with each other. In another example, the endfaces of the plurality of first conductors 280, 282-1, 282-2, 282-3, 282-4 are in a non-coplanar disposition, e.g., having staggered depths relative to the bottom surface 210.

In some embodiments, and as shown, the plurality of first conductors 280, 282-1, 282-2, 282-3, 282-4 have a concentric disposition. In some embodiments, the center of the concentric disposition corresponds to the axis of rotation R of the external connector 255. The plurality of first conductors 280, 282-1, 282-2, 282-3, 282-4 comprise a central conductor 280 and a plurality of arcuate conductors 282-1, 282-2, 282-3, 282-4 that partly circumscribe the central conductor 280. In some embodiments, and as shown, the central conductor 280 has a circular shape, the arcuate conductors 282-2, 282-3 each have a radius of curvature corresponding to a first circle 286 with a greater surface area than that of the central conductor 280, and the arcuate conductors 282-1, 282-4 each have a radius of curvature corresponding to a second circle 288 with a greater surface area than the first circle 286. As shown, the plurality of arcuate conductors 282-1, 282-2 have a same arc angle measurement and align with each other, and the plurality of arcuate conductors 282-3, 282-4, have a same arc angle measurement and align with each other. As shown in FIG. 2B, the length of the arcuate conductors 282-1, 282-4 is longer than the length of the arcuate conductors 282-2, 282-3. Other implementations of the connector interface 205 may have different lengths of the arcuate conductors 282-1, 282-2, 282-3, 282-4, such as the same length, the arcuate conductors 282-2, 282-3 being longer than the arcuate conductors 282-1, 282-4, the arcuate conductors 282-1, 282-2, 282-3, 282-4 not being arranged as symmetrical pairs, and so forth.

Other implementations may include different numbers and/or different dispositions of the plurality of first conductors 280, 282-1, 282-2, 282-3, 282-4 that provide a selective connection with one or more conductors of the external connector 255 at certain rotational positions and/or a continuous connection with one or more conductors of the external connector 255 at multiple rotational positions. For example, other implementations may omit the central conductor 280, may substitute annular conductors for one or more of the arcuate conductors 282-1, 282-2, 282-3, 282-4 (e.g., circumscribing the central conductor 280 entirely), may include conductors that extend substantially along the first circle 286 or the second circle 288 but are not arcuate (e.g., formed as linear segments), and so forth. In some embodiments, the selective connection and/or continuous connection with the one or more conductors of the external connector 255 supports a sequenced connection or disconnection of the external connector 255 with the connector interface 205.

An end portion 294 of the external connector 255 defines a central endface 292 that is substantially circular, as well as flanges 296-1, 296-2, 296-3 disposed along a circumference of the central endface 292. The circle of the central endface 292 has a surface area that is less than the surface area of the circle of the central recess 276, such that the central endface 292 may be received into the central recess 276 when the flanges 296-1, 296-2, 296-3 are aligned with, and received into, the circumferential slots 278-1, 278-2, 278-3. As shown, the flanges 296-1, 296-2, 296-3 are evenly distributed (e.g., three flanges 296-1, 296-2, 296-3 that are spaced apart by 120 degrees), although different numbers of the flanges 296-1, 296-2, 296-3 and different spacing between the flanges 296-1, 296-2, 296-3 (including regular and irregular spacing) are also contemplated.

The external connector 255 further comprises a plurality of second conductors 299-1, 299-2, . . . , 299-5 projecting from the end portion 294 of the external connector 255. The plurality of second conductors 299-1, 299-2, . . . , 299-5 have a linear disposition, although other dispositions are also contemplated. The plurality of second conductors 299-1, 299-2, . . . , 299-5 have a fixed disposition relative to the flanges 296-1, 296-2, 296-3.

In some embodiments, the connector interface 205 and the external connector 255 are dimensioned such that forming the connection between the plurality of first conductors 280, 282-1, 282-2, 282-3, 282-4 and the plurality of second conductors 299-1, 299-2, . . . , 299-5 applies a compressive force therebetween, which tends to improve the conductive connections, e.g., by making them more resilient against vibration. In some embodiments, the plurality of second conductors 299-1, 299-2, . . . , 299-5 comprise spring-loaded pins (also referred to as “pogo pins”), and the plurality of first conductors 280, 282-1, 282-2, 282-3, 282-4 comprise planar lands (also referred to as “targets”) on a PCB or other substrate. The plungers of the spring-loaded pins are displaced, and the springs of the spring-loaded pins compressed, when the external connector 255 is attached to the connector interface 205.

In some embodiments, the central endface 292 is contoured to define a recess 298 disposed between two of the flanges 296-1, 296-3. The connector interface 205 further comprises a projection 284 that is recessed from the bottom surface 210 and that extends into the central recess 276. As the portions of the external connector 255 are received into the recess 272, the projection 284 is received into the recess 272 only when the external connector 255 is in a correct orientation. Otherwise, when the external connector 255 has an incorrect orientation, the projection 284 contacts the central endface 292, limiting the insertion of the external connector 255 into the recess 272 and preventing the connection of the plurality of first conductors 280, 282-1, 282-2, 282-3, 282-4 with the plurality of second conductors 299-1, 299-2, . . . , 299-5. Stated another way, the combination of the projection 284 and the recess 298 ensures a correct orientation of the external connector 255 when connecting the plurality of first conductors 280, 282-1, 282-2, 282-3, 282-4 with the plurality of second conductors 299-1, 299-2, . . . , 299-5. Other techniques are also contemplated for ensuring the correction orientation of the external connector 255, such as an irregular (or asymmetrical) spacing of the flanges 296-1, 296-2, 296-3 and the corresponding circumferential slots 278-1, 278-2, 278-3.

Thus, to connect the external device 160 with the electronic device 100, a user may manipulate the external connector 255 into a proper alignment with the connector interface 205 (e.g., a rotational position such that the flanges 296-1, 296-2, 296-3 are received into the circumferential slots 278-1, 278-2, 278-3 and/or the projection 284 is received into the recess 298). From this rotational position, the external connector 255 may be inserted into the recess 272 to at least a minimum depth from the bottom surface 210. In some embodiments, the distal end of the external connector 255 (here, the plurality of second conductors 299-1, 299-2, 299-3, 299-4, 299-5) contacts the recessed surface 274 at the minimum depth. In other embodiments the distal end of the external connector 255 does not contact the recessed surface 274 at the minimum depth.

The user rotates the external connector 255 in a first direction relative to the axis of rotation R (e.g., a clockwise direction), causing the flanges 296-1, 296-2, 296-3 to advance within the circumferential slots 278-1, 278-2, 278-3. The external connector 255 may be rotated into a rotational position where the flanges 296-1, 296-2, 296-3 are retained in the circumferential slots 278-1, 278-2, 278-3 (a “retained position”), whether by a distinct retention mechanism such as a detent or by the relative geometry of the flanges 296-1, 296-2, 296-3 and the circumferential slots 278-1, 278-2, 278-3. Other types of retention mechanisms are also contemplated.

In some embodiments, a sequenced connection of the plurality of first conductors 280, 282-1, 282-2, 282-3, 282-4 and the plurality of second conductors 299-1, 299-2, . . . , 299-5 occurs as the external connector 255 is rotated toward the retained position. In one exemplary implementation, one or more power conductors (e.g., supply voltage, ground) are first connected, then one or more signal conductors are connected.

Removal of the external connector 255 from the connector interface 205 generally follows a reverse process. The user applies at least a minimum rotational force in a second direction relative to the axis of rotation R (e.g., a counter-clockwise direction), causing the flanges 296-1, 296-2, 296-3 to withdraw within the circumferential slots 278-1, 278-2, 278-3 and the external connector 255 to exit from the retained position. In some embodiments, a sequenced disconnection of the plurality of first conductors 280, 282-1, 282-2, 282-3, 282-4 and the plurality of second conductors 299-1, 299-2, . . . , 299-5 occurs as the external connector 255 is rotated away from the retained position. When the external connector 255 is rotated to the aligned position, the user may remove the external connector 255 from the connector interface 205.

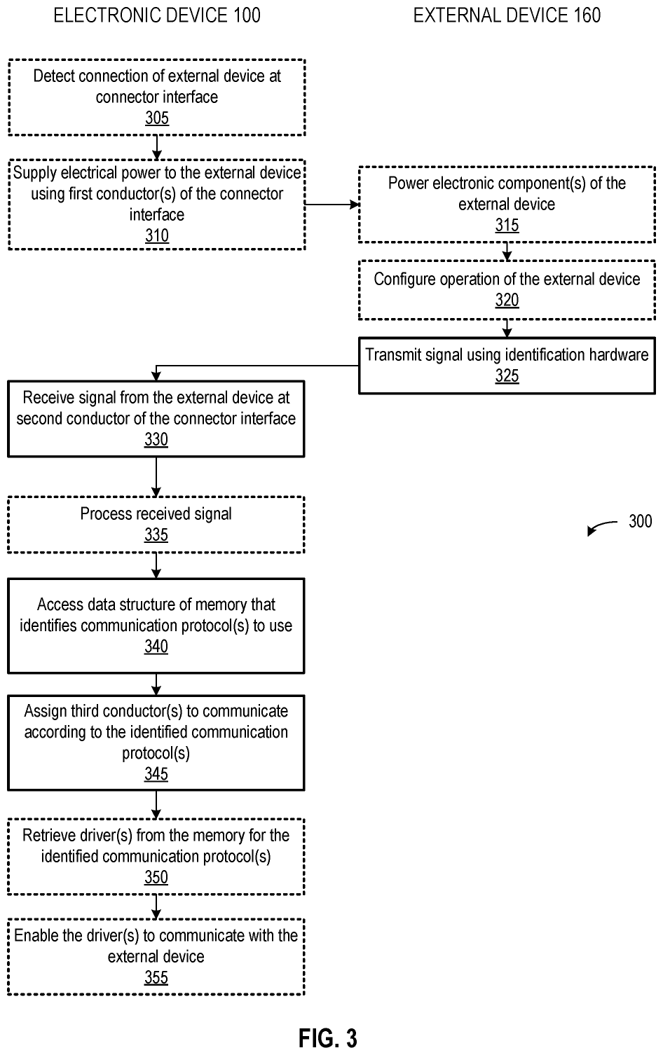

FIG. 3 provides an exemplary method 300 of dynamic configuration of a connector interface, according to one or more embodiments. The method 300 may be used in conjunction with other embodiments described herein. For example, the method 300 may be performed by the electronic device 100 in conjunction with the external device 160 following connection of the external connector 255 with the connector interface 205, as discussed above with respect to FIGS. 2A-2C.

The method 300 begins at block 305, where the electronic device 100 optionally detects the connection of the external device 160 at the connector interface 205. Detecting the connection may be performed in any suitable manner; some examples include receiving a signal from the external device 160, acquiring a measurement at the connector interface 205 (e.g., an impedance measurement at a conductor of the connector interface), and so forth. In some embodiments, detecting the connection is performed responsive to the external connector 255 being connected (e.g., rotated by a user to the retained position)).

At block 310, the electronic device 100 optionally supplies electrical power to the external device 160 using one or more first conductors of the connector interface 205. In some embodiments, the one or more first conductors of the connector interface 205 include a supply voltage conductor and a ground conductor. In some alternate implementations, detecting the connection (block 305) may be performed during a session where the external connector 255 is already in a connected arrangement with the connector interface 205. For example, the electronic device 100 may be powered up (or out of a low-power state) and the sensing service 118 determines to begin acquiring measurements of the sensed parameter(s). The electronic device 100 then supplies electrical power to the external device 160.

At block 315, the external device 160 optionally powers one or more electronic components of the external device 160 using the supplied electrical power, such as one or more sensors, one or more computer processors, and so forth.

At block 320, the external device 160 optionally configures its operation. In some embodiments, the external device 160 configures its operation using the supplied electrical power. For example, the external device 160 may measure a voltage level of a plurality of discrete voltage levels for the supply voltage, or may process a modulated signal carried with (e.g., added onto) the supply voltage. In other embodiments, the electronic device 100 may provide a signal on one or more other conductors of the connector interface 205.

In some embodiments, the external device 160 may include a plurality of different sensors, which in some cases may be of different types, and the electronic device 100 may signal a requested sensor capability through the supplied electrical power and/or the signal. Logic aboard the external device 160 may operate electronic switching circuitry to connect one or more sensors to the plurality of second conductors 299-1, 299-2, . . . , 299-5 of the external connector 255.

At block 325, the external device 160 transmits a signal using identification hardware 175 of the external device 160. In some embodiments, the identification hardware 175 may include passive components (e.g., the identification hardware 175 outputs a fixed DC voltage level using voltage divider circuitry). In some embodiments, the identification hardware 175 may include electronic components, such as one or more computer processors, that generate the signal. The signal distinguishes which one, of the plurality of different types of external devices 160 supported by the electronic device 100, is currently connected to the connector interface 205.

At block 330, the electronic device 100 receives the signal at one or more second conductors of the connector interface 205. In some embodiments, the one or more second conductors are designated to be operated as dedicated identification conductor(s). At block 335, the electronic device 100 optionally processes the received signal, e.g., performs measurement(s) and/or conditioning of the received signal. In some embodiments, the processing the received signal comprises determining one or more signal characteristics of the received signal.

At block 340, the electronic device 100 accesses a data structure of the memory that identifies at least one of a plurality of different communication protocols to use based on which one of the plurality of different types of external devices 160 is currently connected to the connector interface 205 according to the received signal. In some embodiments, accessing the data structure comprises performing a lookup in the data structure using a result of the processing at block 335. One non-limiting example is using a measured voltage of the received signal to perform the lookup.

At block 345, the electronic device 100 assigns one or more third conductors to communicate according to the at least one identified communication protocol. In this way, the one or more third conductors are operated differently by the electronic device 100 when different ones of the plurality of communication protocols are used.

At block 350, the electronic device 100 optionally retrieves one or more drivers from the memory for the at least one identified communication protocol. At block 355, the electronic device 100 optionally enables the one or more drivers to communicate with the external device 160. The method 300 ends following completion of block 355.

FIG. 4 illustrates an exemplary data structure 400 that identifies at least one communication protocol used by the external device, according to one or more embodiments. The features illustrated in FIG. 4 may be used in conjunction with other embodiments described herein. For example, the data structure 400 represents one exemplary implementation of the data structure 120 of FIG. 1.

The data structure 400 comprises a plurality of records 420-1, 420-2, . . . , 420-8, each of which includes a plurality of fields 402, 404, . . . , 416. As shown, the fields include a signal characteristic field 402 for values of one or more signal characteristics (analog or digital domain) of the received signal from the external device 160, a number of protocols field 404 for a count of the communication protocols associated with a certain value of the signal characteristic field 402, protocol fields 406, 408 for specifying which communication protocol(s) are to be applied by the electronic device 100, application fields 410, 412 for specifying the particular application(s) of the respective protocol(s)), and assignment fields 414, 416 for specifying the assignments for respective conductors of the connector interface 205. While only two (2) conductors are shown (Conductor 1, Conductor 2) for simplicity of description, any alternate number of conductors are also contemplated (such as one (1), three (3), four (4) or more). In some embodiments, the electronic device 100 may use the values of the application fields 410, 412 to process the received signals on the assigned conductors differently. Other compositions of the fields of the data structure 400 are also contemplated.

For the example of FIG. 4, the signal characteristic field 402 corresponds to values of a measured voltage of the received signal. The record 420-1 has a value of 0.3 V in the signal characteristic field 402, which corresponds to a single protocol (I2C), a temperature application, and the assignment of Conductor 1 to serial data (SDA), and Conductor 2 to serial clock (SCL) of the single protocol.

The record 420-2 has a value of 0.6 V in the signal characteristic field 402, which corresponds to a single protocol (I2C), a vibration application, and the assignment of Conductor 1 to serial data (SDA), and Conductor 2 to serial clock (SCL) of the single protocol.

The record 420-3 has a value of 0.9 V in the signal characteristic field 402, which corresponds to a single protocol (System Management Bus (SMBus)), a temperature application, and the assignment of Conductor 1 to SMBus data (SMBDAT), and Conductor 2 to SMBus clock (SMBCLK) of the single protocol.

The record 420-4 has a value of 1.2 V in the signal characteristic field 402, which corresponds to a single protocol (analog input/output (I/O)), an atmospheric pressure application, and the assignment of Conductor 1 to input pressure (P_IN) of the single protocol.

The record 420-5 has a value of 1.5 V in the signal characteristic field 402, which corresponds to a single protocol (digital I/O), a break-beam application, and the assignment of Conductor 1 to input break-beam (B_IN) of the single protocol.

The record 420-6 has a value of 1.8 V in the signal characteristic field 402, which corresponds to a single protocol (1-Wire), a temperature application, and the assignment of Conductor 1 to input temperature (T_IN) of the single protocol.

The record 420-7 has a value of 2.1 V in the signal characteristic field 402, which corresponds to multiple protocols (two instances of 1-Wire), a temperature application and a humidity application, the assignment of Conductor 1 to input temperature (T_IN) of the first (1-Wire) protocol, and the assignment of Conductor 2 to input humidity (H_IN) of the second (1-Wire) protocol.

The record 420-8 has a value of 2.4 V in the signal characteristic field 402, which corresponds to multiple protocols (1-Wire and digital I/O), a temperature application and a break-beam application, the assignment of Conductor 1 to input temperature (T_IN) of the first (1-Wire) protocol, and the assignment of Conductor 2 to input break-beam (H_IN) of the second (digital I/O) protocol.

Thus, using the data structure 400, the electronic device 100 may dynamically configure the connector interface 205 to accommodate multiple types of external devices 160 when the external device 160 is connected to the connector interface 205. The electronic device 100 dynamically assigns at least one of a plurality of different communication protocols to be used on a set of a plurality of conductors of the connector interface 205 according to the data structure 400. While the particular example values of the data structure 400 were provided for simplicity of description, the personal of ordinary skill will understand that the data structure 400 may support communication using any number of different communication protocols and any number of conductors available within the connector interface 205.

FIGS. 5A and 5B illustrate exemplary implementations of the identification hardware 175 of an external device 160, according to one or more embodiments. The features depicted in diagrams 500 and 510 may be used in conjunction with other embodiments discussed herein.

Diagram 500 depicts an implementation of the external device 160 where the identification hardware 175 includes passive components, e.g., implemented as a relatively inexpensive sensor probe. In this implementation, the external device 160 includes voltage divider circuitry 505 (e.g., an impedance network) that receives electrical power on the power link 174, and based on the voltage of the electrical power, outputs a voltage on the communicative link 176 that distinguishes the type of the external device 160 (e.g., the configuration of sensors, applications, and/or protocols of the external device 160). In this way, external devices 160 of different types may be manufactured or electronically configured to have different impedance values and/or ratios within the voltage divider circuitry 505.

Diagram 510 depicts an implementation of the external device 160 where the identification hardware 175 includes electronic components, e.g., implemented as a “smart” sensor device having a suite of sensors that may be individually selectable. In this implementation, the external device 160 comprises one or more computer processors 515, which in some cases may have comparable structure and/or functionality as the one or more computer processors 125 discussed above. The external device 160 further comprises a memory 520, which in some cases may have comparable structure and/or functionality as the memory 110 discussed above. Collectively, the one or more computer processor(s) 515 and the memory 520 provide the identification hardware 175 of the external device 160.

The external device 160 further comprises one or more other sensors 525, which may be of any suitable type(s) and which may use any suitable communication protocol(s). The memory 520 comprises a sensor selection service 522, which may be implemented as computer-readable code that is executed by the one or more computer processors 515 to determine a sensor configuration and/or report the sensor configuration to the electronic device 100. In other implementations, the sensor selection service 522 may be implemented as logic within the one or more computer processors 515.

The one or more computer processors 515 receive electrical power from the electronic device 100 on the power link 174. In some embodiments, the one or more computer processors 515 also receive (whether on the power link 174 or the communicative link 176) a configuration signal from the electronic device 100 that provides a requested sensor configuration. The sensor selection service 522 determines a sensor configuration of one or more selected sensors based on the requested sensor configuration. For example, the sensor selection service 522 may include logic to meet the requested sensor configuration where possible, to prioritize certain sensor types, to minimize overall power consumption of the external device 160, to maximize the number of sensors used within a given power consumption level, and so forth. Based on the determined sensor configuration of the external device 160, the one or more computer processors 515 establish the connection of the one or more selected sensors with the connector 165. For example, the one or more computer processors 515 may supply electrical power to (or withhold electrical power from) various sensors on the links 530 (e.g., where the sensors are not powered separately using the power link 172), may transmit control signals on the links 530 to enable or disable operation of the various sensors, and/or may transmit control signals on the link 540 to electronic switching circuitry 535 disposed between the various sensors and the connector 165 to enable or disable conductive paths between the various sensors and the conductors of the connector 165.

Based on the determined sensor configuration, the sensor selection service 522 transmits a signal to the electronic device 100 using the communicative link 176, which identifies the type (e.g., the current configuration of sensors, applications, and/or protocols) of the external device 160 to the electronic device 100 (e.g., in conjunction with the data structure 120), and distinguishes the external device 160 from other types of external devices 160 supported by the electronic device 100.

### CONCLUSION

In the above description, numerous specific details such as resource partitioning/sharing/duplication embodiments, types and interrelationships of system components, and logic partitioning/integration choices are set forth in order to provide a more thorough understanding. It will be appreciated, however, by one skilled in the art, that the invention may be practiced without such specific details. In other instances, control structures, logic embodiments, opcodes, means to specify operands, and full software instruction sequences have not been shown in detail since those of ordinary skill in the art, with the included descriptions, will be able to implement what is described without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations and/or structures that add additional features to some embodiments. However, such notation should not be taken to mean that these are the only options or optional operations, and/or that blocks with solid borders are not optional in certain embodiments.

In the preceding description and following claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary embodiments in the other figures. However, the operations of the flow diagrams can be performed by embodiments other than those discussed with reference to the other figures, and the embodiments discussed with reference to these other figures can perform operations different from those discussed with reference to the flow diagrams.

While the above description includes several exemplary embodiments, those skilled in the art will recognize that the invention is not limited to the embodiments described and can be practiced with modification and alteration within the spirit and scope of the appended claims. The description is thus illustrative instead of limiting.

What is claimed is:

1. An electronic device comprising:
an enclosure that defines an internal volume and a plurality of external surfaces;
a connector interface comprising a plurality of conductors that are exposed at an external surface of the plurality of external surfaces, or through an opening formed in the external surface, wherein the electronic device supports the connection of any one of a plurality of different types of external devices to the connector interface;
a memory disposed in the internal volume; and
one or more computer processors disposed in the internal volume and configured to:
receive a signal, when one of the plurality of different types of external devices is currently connected to the connector interface, at a first conductor of the plurality of conductors, wherein the signal distinguishes which one of the plurality of different types of external devices is currently connected to the connector interface;
access, based on the received signal, a data structure in a storage of the memory that identifies at least one of a plurality of different communication protocols to use based on which one of the plurality of different types of external devices is currently connected to the connector interface according to the received signal; and
assign one or more second conductors of the plurality of conductors to communicate according to the at least one identified communication protocol, wherein the one or more second conductors are operated differently when different ones of the plurality of communication protocols are used.

2. The electronic device of claim 1, wherein the one or more computer processors are further configured to:
retrieve, from the storage, one or more drivers for the at least one identified communication protocol; and
enable the one or more drivers to communicate with the external device using the one or more second conductors.

3. The electronic device of claim 1,
wherein the one or more computer processors are further configured to perform processing of the received signal, and
wherein accessing the data structure comprises performing a lookup in the data structure using a result of the processing.

4. The electronic device of claim 3, wherein the processing comprises measuring a voltage of the received signal.

5. The electronic device of claim 1, wherein receiving the signal from the external device is responsive to an external connector of the external device being connected to the connector interface.

6. The electronic device of claim 5, wherein the one or more computer processors are further configured to:
supply, responsive to the external connector being connected to the connector interface, electrical power to the external device using one or more third conductors of the plurality of conductors.

7. The electronic device of claim 5,
wherein the enclosure further defines a recess from the external surface, the recess having one or more circumferential slots that extend to the opening formed in the external surface and that receive one or more flanges of the external connector, and
wherein, while the one or more flanges are received in the one or more circumferential slots, rotation of the external connector causes the one or more flanges to slide within the one or more circumferential slots into a retained position of the external connector, in which a second plurality of conductors of the external connector, having a fixed disposition relative to the one or more flanges, are connected to the first plurality of conductors.

8. The electronic device of claim 7, wherein the second plurality of conductors are in a linear disposition, wherein the first plurality of conductors includes one or more arcuate conductors that connect to a corresponding one or more of the second plurality of conductors for a range of rotational positions of the external connector including the retained position.

9. The electronic device of claim 8, wherein the first plurality of conductors is in a concentric disposition.

10. The electronic device of claim 9, wherein the first plurality of conductors comprises a central conductor and a plurality of arcuate conductors.

11. The electronic device of claim 1, wherein the data structure comprises:
at least a first record that identifies a single protocol to use based on a value of a signal characteristic field for the received signal; and
at least a second record that identifies multiple protocols to use based on the value of the signal characteristic field.

12. The electronic device of claim 11, wherein the data structure further comprises:
within one or both of the first record and the second record, one or more application fields that identify an operational type of the external device.

13. An integrated circuit comprising:
an external connector interface comprising a plurality of conductors, wherein the integrated circuit supports the connection of any one of a plurality of different types of external devices to the external connector interface;
a memory; and
one or more processor cores configured to:
receive a signal, when one of the plurality of different types of external devices is currently connected to the external connector interface, at a first conductor of the plurality of conductors, wherein the signal distinguishes which one of the plurality of different types of external devices is currently connected to the connector interface;
access, based on the received signal, a data structure in a storage of the memory that identifies at least one of a plurality of different communication protocols to use based on which one of the plurality of different types of external devices is currently connected to the connector interface according to the received signal; and
assign one or more second conductors of the plurality of conductors to communicate according to the at least one identified communication protocol, wherein the one or more second conductors are operated differently when different ones of the plurality of communication protocols are used.

14. The integrated circuit of claim 13, wherein the one or more processor cores are further configured to:
retrieve, from the storage, one or more drivers for the at least one identified communication protocol; and
enable the one or more drivers to communicate with the external device using the one or more second conductors.

15. The integrated circuit of claim 13,
wherein the one or more processor cores are further configured to measure a voltage of the received signal, and
wherein accessing the data structure comprises performing a lookup in the data structure using the measured voltage.

16. The integrated circuit of claim 13, wherein the one or more processor cores are further configured to:
supply electrical power to the external device using one or more third conductors of the plurality of conductors.

17. The integrated circuit of claim 13, wherein the plurality of conductors are a plurality of general-purpose input/output (GPIO) pins of the integrated circuit that are individually assignable to any one of a plurality of functions supported by the one or more processor cores.

18. A non-transitory machine-readable storage medium that provides instructions that, when executed by a processor of an electronic device, cause the processor to perform operations comprising:
receiving a signal from an external device at a first conductor of a plurality of conductors of a connector interface of the electronic device, wherein the electronic device supports the connection of any one of a plurality of different types of external devices to the connector interface, wherein the signal distinguishes which one of the plurality of different types of external devices is currently connected to the connector interface;
accessing, based on the received signal, a data structure in a storage of a memory of the electronic device that identifies at least one of a plurality of different communication protocols to use based on which one of the plurality of different types of external devices is currently connected to the connector interface according to the received signal; and
assigning one or more second conductors of the plurality of conductors to communicate according to the at least one identified communication protocol, wherein the one or more second conductors are operated differently when different ones of the plurality of communication protocols are used.

19. The non-transitory machine-readable storage medium of claim 18, the operations further comprising:
retrieving, from the storage, one or more drivers for the at least one identified communication protocol; and
enabling the one or more drivers to communicate with the external device using the one or more second conductors.

20. The non-transitory machine-readable storage medium of claim 18, the operations further comprising:
performing processing of the received signal,
wherein accessing the data structure comprises performing a lookup in the data structure using a result of the processing.
